(19) United States
(12) Patent Application Publication
(10) Pub. No.: US 2010/0134314 A1
(43) Pub. Date: Jun. 3, 2010

(54) POWER SWITCH

(76) Inventors: Chih-Hua HSU, Taipei City (TW); Yung-Shun Chiang, Tucheng City (TW)

Correspondence Address: Muncy, Geissler, Olds & Lowe, PLLC, 4000 Legato Road, Suite 310, FAIRFAX, VA, 22033, US

(21) Appl. No.: 12/326,359

(22) Filed: Dec. 2, 2008

(51) Int. Cl. G08B 5/22; G09F 9/33; G08B 21/00

(52) U.S. Cl. 340/815.45; 340/644; 340/664

(57) ABSTRACT

A power switch, in which one end is electrically connected to a power supply terminal, while another end is electrically connected to an electronic device, and the power switch is used to switch the power supply state of an electronic device. The present invention primarily effects an electrical connection between two indicator lights and a current circuit within the power switch, thereby enabling the user to know the power supply state of the power supply terminal, the power supply state of the electronic device and whether the electronic device is operating normally or not.

### BACKGROUND OF THE INVENTION

(a) Field of the Invention

The present invention relates to a power switch, which is used to switch the power supply state of an electronic device, and more particularly to a power switch which enables a user to differentiate states, including the state of a power supply terminal, power state of an electronic device and whether the electronic device is operating normally or not according to lighting or extinguished states of indicator lights fitted to the power switch.

(b) Description of the Prior Art

Referring to FIG. 1, which shows an external elevational view of a power switch of the prior art, and a prior art power switch 10 depicted in the drawing is structured from an operational switch 102 and a switch base 101, wherein pressing the operational switch 102 effects a switching operation that enables actuating or shutting off a power source. Moreover, an indicator light 103 is fitted to the operational switch 102, and an electrical connection is effected between the indicator light 103 and a current circuit within the operational switch 102. During implementation, one of the terminals of the power switch 10 electrically connected to a power supply terminal is first used to transmit power, and then another terminal electrically connected to an electronic device (such as a lamp, and the like) supplies the power thereto. When the operational switch 102 is pressed on the side provided with the indicator light 103, then current is caused to flow, thereby enabling the electronic device to operate, at which time, the indicator light 103 assumes an extinguished state. In comparison, if the operational switch 102 is pressed on the other side (the side not provided with the indicator light 103), then an electric current is unable to flow, and the electronic device stops operating, whereupon the indicator light 103 lights up, thereby enabling the user to be visually aware that the present state is a non-current conducting state. Moreover, in an environment where light is insufficient, the light emitted by the indicator light 103 enables locating the position of the operational switch 102. However, the indicator light 103 of the power switch 10 of the prior art only provides functionality to identify the position of the operational switch 102 and the present current conducting state. Hence, if the operational switch 102 is in an actuated state, but the electronic device is not operating, the user has no way of knowing whether the power supply terminal or the electronic device is malfunctioning.

The load on prior art circuit breakers used in household main electric power supplies is 50 A (ampere), which, after distribution, amounts to 20 A˜30 A on each circuit breaker. As an example, if the average load on an electric appliance product is within 100 W, then the electric current will not exceed 1 A. Hence, if an abnormality causes an overcurrent, then the circuit breakers and normal power supply are not affected, thereby causing the load on the electric appliance product to exceed 1 A, resulting in dangers of load overheating and combustion.

### SUMMARY OF THE INVENTION

In light of the aforementioned problems, the inventor of the present invention, having accumulated many years of experience in the design of related products, has carried out extensive relevant research in the current conducting characteristics of current circuits and design thereof. Accordingly, a primary objective of the present invention is to further enable display states of indicator lights to produce a light display in accordance with the corresponding current conducting state, thereby enabling the user to quickly determine the conducting state of the electric current. Furthermore, the present invention using light and extinguished states of multiple indicator lights to display whether current is flowing or not, the power supply state of a power supply terminal, and whether an electrically connected electronic device is operating normally or not, thereby increasing convenience of use.

In order to achieve the aforementioned objective, the present invention is primarily structured to comprise a switch base, a first indicator light, a second indicator light, an operational switch and a current circuit module, wherein the operational switch is fitted to the switch base, and an electronic circuit within the switch place is used to enable electrical connecting to the mains power supply. Furthermore, a cover covers the periphery of the operational switch, and enables the operational switch to protrude outside the switch base and be protected by the cover. Moreover, the first indicator light and the second indicator light are separately fitted to appropriate positions on the surface of the cover, and an electrical connection is effected between the first indicator light and the second indicator light and the current circuit within the switch base. In addition, switching of the operational switch is used to change the current circulation direction of the internal current circuit, thereby causing light and extinguished states of the first indicator light and the second indicator light to change in accordance with switching of the switch. Moreover, the first indicator light and the second indicator light emit indicative lights according to the current conducting state of the power supply terminal and whether an electronic device is operating normally or not. The present invention further uses an overcurrent protection cutout device which is able to effectively prevent an electronic device from smoking and bursting into flame, thereby improving overall safety of use, and achieving effectiveness to provide a power supply indicator and power supply state indicator for an electronic device, as well as an operating indicator.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an external elevational view of a power switch of the prior art.

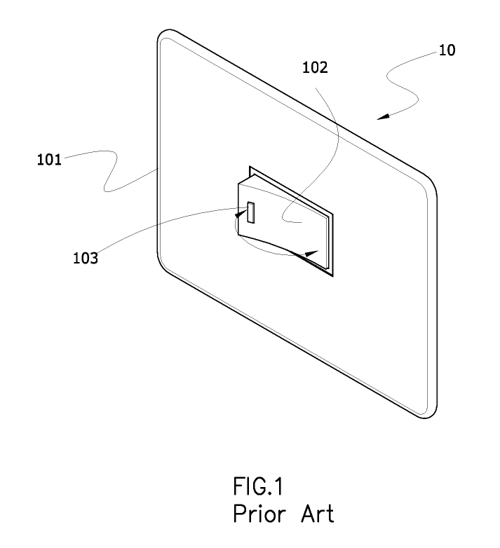

FIG. 2 is an external elevational view of the present invention.

FIG. 3 is a schematic view depicting a layout of a current circuit module within the present invention.

FIG. 4 is an operational schematic view of the current circuit module.

FIG. 5 is a chart detailing operational states of indicator lights according to the present invention.

### DETAILED DESCRIPTION OF THE PREFERRED EMBODIMENTS

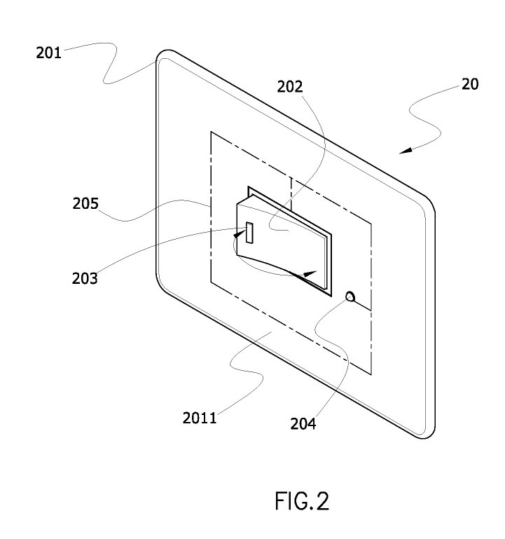

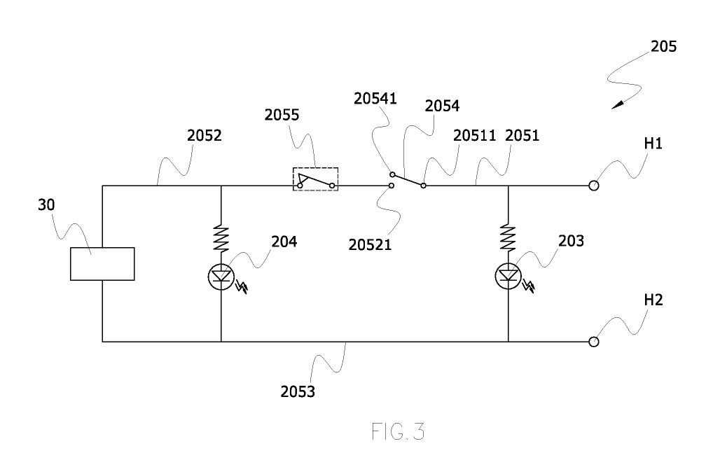

Referring to FIG. 2, which shows an external elevational view of the present invention, in which a power switch 20 depicted in the drawing is primarily structured to comprise a switch base 201, an operational switch 202, a first indicator light 203, a second indicator light 204 and a current circuit module 205. In addition, a cover 2011 circumferentially covers the periphery of the operational switch 202 and is mutually fitted to the switch base 201 to complete assembly thereof, thereby protecting the operational switch 202 and adding to its aesthetic appearance. The present invention places emphasis on the design of the current circuit module 205 within the switch base 201, while the drawing only depicts the external appearance of one possible implementation of the present invention, nevertheless, the current circuit module 205 assembled within the switch base 201 is able to effect a conducting current or broken circuit state through switching of the operational switch 202. Furthermore, hardware configuration of the overall exterior appearance (such as the cover 2011) is further equipped with the first indicator light 203 and the second indicator light 204, and an electrical connection is effected between the two indicator lights 203, 204 and the current circuit module 205 within the switch base 201. Lighting and extinguishing of the first indicator light 203 and the second indicator light 204 are primarily used to display states, and enable the user to visually see and identify the position of the switch base 201, as well as enabling identifying whether or not the power switch 20 is in a current conducting state, whether or not power from a power supply terminal is normal and whether or not an electrically connected electronic device (not shown in the drawings) is operating normally. Furthermore, as depicted in FIG. 2, the first indicator light 203 and the second indicator light 204 are light-emitting bodies, such as light-emitting diodes, able to emit light when an electric current is passed therethrough, and are fitted to appropriate positions of the exterior of the cover 2011, the cover 2011 being formed with corresponding holes to enable the two indicator lights 203, 204 to emit light therethrough when the cover 2011 is made to cover the switch base 201, thereby enabling the user to visually know operating states (or the cover 2011 can be made from transparent plastic material, thereby enabling the user to directly see the emitted light), or one of the indicator lights can be directly assembled to the operational switch 202. The indicator lights disclosed in the present invention generally refer to various types of light-emitting bodies, such as light-emitting diodes, which are electrically connected to the current circuit module 205 within the switch base 201, and which produce a light display in accordance with the corresponding current direction (current conducting or broken circuit), whether or not current from the power supply terminal is conducting normally and whether or not an electrically connected electronic device 30 (see FIG. 3) is operating normally. For example, changes in lighting and extinguishing of lights and light conversion enable the user to visually know the present current conducting state and state of the electronic device, as well enabling identifying the position of the power switch 20 in the dark.

Referring to FIG. 3, which shows a schematic view of a layout of the current circuit module according to the present invention, and as depicted in the drawing, the current circuit module 205 comprises a first circuit section 2051, a second circuit section 2052 and a third circuit section 2053, wherein one end of the first circuit section 2051 establishes an electrical connection with an alternating current live terminal H1, while a first electrical contact 20511 is formed at the other end. The first electrical contact 20511 is electrically connected with a movable circuit section 2054, and a second electrical contact 20541 is formed at one end of the movable circuit section 2054. Moreover, through a press switching method, the movable circuit section 2054 enables forcing the second electrical contact 20541 to make electrical contact with a third electrical contact 20521 formed at one end of the second circuit section 2052, thereby enabling an electric current to flow between the two electrical contacts 20511, 20521. An automatic cutout unit 2055 is electrically connected within the second circuit section 2052, and another end of the second circuit section 2052 is electrically connected to the electronic device 30. One of the ends of the third circuit section 2053 is electrically connected to a neutral terminal H2, while the other end is electrically connected to the electronic device 30. Furthermore, the first indicator light 203 is electrically connected between the first circuit section 2051 and the third circuit section 2053, and the second indicator light 204 is electrically connected between the second circuit section 2052 and the third circuit section 2053. As shown in FIG. 3, the drawing depicts a power-off state (OFF), and because of the principle of current phase difference, after alternating current enters the live terminal H1, because the second electrical contact 20541 of the movable circuit section 2054 is not in contact with the third electrical contact 20521 of the second circuit section 2052, thus, the electric current is unable to flow into the second circuit section 2052. At which time, because no current is being conducted through the electronic device 30, thus, the electronic device 30 cannot operate. Referring again to the drawing, at this time, even though the electric current is unable to flow into the second circuit section 2052, however, the current can pass through the first circuit section 2051 and the first indicator light 203, thus, the first indicator light 203 emits light, and the electric current flows to the neutral terminal H2, that is, in the state wherein the electronic device 30 has not received an electric current, the first indicator light 203 is in a lit state.

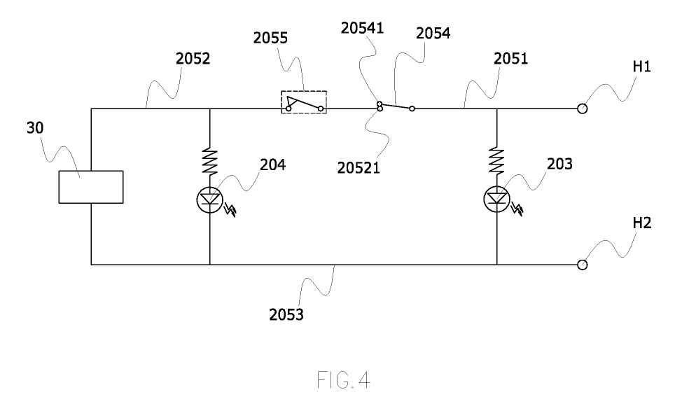

Referring to FIG. 4, which shows an operational schematic view of the current circuit module according to the present invention, and as shown in the figure, the drawing depicts a power-on (conducting) state (ON), at which time, because the power source is in an on-state, thus, the movable circuit section 2054 is subjected to press switching, thereby forcing the second electrical contact 20541 to make electrical contact with the third electrical contact 20521 of the second circuit section 2052, causing electric current to pass through the first circuit section 2051, the movable circuit section 2054 and the second circuit section 2052, after which the current flows into the electronic device 30, thereby actuating the electronic device 30 and enabling it to operate. The electric current then flows through the third circuit section 2053 and to the neutral terminal H2. Hence, when the power is actuated (ON) and electric current is flowing through the entire current circuit, then the first indicator light 203 and the second indicator light 204 are actuated by the electric current and light up, that is, when the power is actuated (ON), and the two indicator lights 203, 204 present a state wherein they are both lit up, then the user is visually able to know that the circuit is in a normal current conducting state.

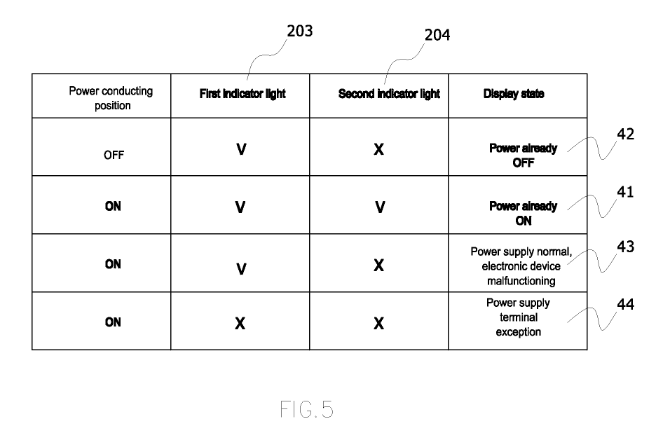

Referring to FIG. 4 and FIG. 5, which show the operational schematic view and a chart detailing operational states respectively of the indicator lights 203, 204, and from the aforementioned it can be known that when the power is actuated (ON), then both the first indicator light 203 and the second indicator light 204 light up, and such a state represents “power already ON” 41. When the power is shut off (OFF), then the first indicator light 203 lights up, while the second indicator light 204 does not light up, and such a state represents “power already OFF” 42. Moreover, the present invention is further able to use the light display state of the two indicator lights to know whether the power supply at the power supply terminal (that is, the live terminal H1) is normal or not, and whether the electronic device 30 is damaged or not. When the power is in an actuated state (ON), then the electronic device 30 is in an operational state. If the electronic device 30 is damaged, then the electric current is unable to flow through the electronic device 30, and the electric current being unable to flow through the electronic device 30 results in an excessive load on the second circuit section 2052, which further forces the automatic cutout unit 2055 to trip the current circuit (that is, cause a circuit break), thereby resulting in the electric current being unable to pass through the second circuit section 2052. Hence, electric current being unable to pass through the second circuit section 2052 flows through the first circuit section 2051 and into the third circuit section 2053 through the first indicator light 203, thereby enabling the electric current to flow back to the neutral terminal H2, at which time the first indicator light 203 is actuated by the alternating current received and lights up, that is, when the operational switch 202 (see FIG. 2) is in an ON position, and only the first indicator light 203 maintains lit, while the second indicator light 204 does not light up, then the user knows that a state wherein “power supply is normal, but the electronic device 30 is malfunctioning” 43 has occurred. Referring again to FIG. 4, and as depicted in the drawing, if the power supply at the power supply terminal is abnormal, then electric current cannot be output from the live terminal H1, thus, because there is no alternating current flowing into the entire current circuit, even if the power source is actuated (ON), the first indicator light 203 and the second indicator light 204 will not light up, at which time, it can be known that a “power supply terminal exception” 44 state has occurred. Referring again to FIG. 5, summarizing the aforementioned description, it can be known that under normal conditions, when the power source is closed (OFF), then the first indicator light 203 lights up, and when the power source is in an actuated state (ON), then both the first indicator light 203 and the second indicator light 204 light up. Furthermore, when the power source is actuated (ON), if the electronic device 30 is damaged or malfunctioning, then the first indicator light 203 lights up, but the second indicator light does not light up; and when the power source is actuated (ON), if the power supply at the power supply terminal is abnormal, then neither the first indicator light 203 nor the second indicator light 204 lights up. Accordingly, the user is able to know operating states, including whether the power source is currently in an actuated or closed state, whether the electronic device 30 is operating normally or not and whether the power supply at the power supply terminal is normal or not according to the light display states of the first indicator light 203 and the second indicator light 204.

According to what has been described above, the present invention primarily facilitates confirming the state of current electricity utilization, and has thus made appropriate improvements to power switches of the prior art. And implementation has shown that the present invention assuredly achieves the objectives of enabling light display states of indicator lights to produce light displays in accordance with the conducting state of the electric current, thereby enabling the user to quickly determine the conducting state of the electric current, as well as further enabling the user to directly visually identify operating states, including whether the power supply at a power supply terminal is normal or not and whether an electronic device is operating normally or not when the power supply is switched on according to the lighting states of two indicator lights, thereby increasing convenience of use.

In conclusion, the effectiveness of the present invention to provide industrial practicability, originality and advancement clearly comply with the essential elements as required for a new patent application, and in accordance with patent law, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A power switch, wherein a power switch is electrically connected between a power supply terminal and an electronic device, and is used to enable switching on or off of the electronic device, the power switch comprises:
a switch base, the switch base is fitted with a switchable operational switch;
a current circuit module, the current circuit module is installed within the switch base, and the switch base is electrically connected to the power supply terminal, the current circuit module is formed from a first circuit section, a second circuit section and a third circuit section, each of the circuit sections are connected in series, and a movable circuit section is electrically connected between the first circuit section and the second circuit section, an automatic cutout unit is electrically installed between the movable circuit section and the second circuit section, and the electronic device is electrically connected between the second circuit section and the third circuit section;
a first indicator light electrically connected between the first circuit section and the third circuit section; and
a second indicator light electrically connected between the second circuit section and the third circuit section.

2. The power switch according to claim 1, wherein one end of the first circuit section is electrically connected to an alternating current live terminal.

3. The power switch according to claim 1, wherein one end of the third circuit section is electrically connected to an alternating current neutral terminal.

4. The power switch according to claim 1, wherein a cover is fitted to an exterior of the operational switch.

5. The power switch according to claim 4, wherein the first indicator light and the second indicator light are fitted to a surface of the cover.

6. The power switch according to claim 4, wherein the first indicator light and the second indicator light are fitted within the cover, and the cover is transparent.

7. The power switch according to claim 1, wherein the first indicator light is fitted to the operational switch.

8. The power switch according to claim 1, wherein the first indicator light is a light-emitting diode.

9. The power switch according to claim 1, wherein the second indicator light is a light-emitting diode.
